(19) United States
(12) Patent Application Publication
(10) Pub. No.: US 2012/0254328 A1
(43) Pub. Date: Oct. 4, 2012

(54) WITHIN-A-RADIUS CHATTING SYSTEM AND SERVICE METHOD THEREOF

(76) Inventor: Jae Hee Lee, Seoul (KR)

(21) Appl. No.: 13/281,387

(22) Filed: Oct. 25, 2011

(30) Foreign Application Priority Data
Mar. 29, 2011 (KR) 10-2011-0028314

(51) Int. Cl. G06F 15/16

(52) U.S. Cl. 709/206

(57) ABSTRACT

The present invention discloses a within-a-radius chatting system and a service method thereof, which can perform chatting with a user of a mobile terminal positioned within a certain radius and meeting a search condition set by the user. The within-a-radius chatting system comprises: an application transmission unit; a member join/authentication unit; a storage unit; a radius information receiving unit; a position information receiving unit; a member search unit; and a chatting relay unit.

### BACKGROUND OF THE INVENTION

1. Field of the Invention

The present invention relates to a within-a-radius chatting system and a service method thereof, which can perform chatting among members using mobile terminals.

2. Background of the Related Art

A terminal can be configured so as to perform a variety of functions. Examples of the variety of functions include a function of performing data and voice communications, a function of photographing pictures or moving images using a camera, a function of storing voices, a function of playing back music files through a speaker system, a function of displaying images or videos, and the like. The terminal may be either a mobile type or a fixed type depending on mobility. Particularly, mobile terminals are diversely developed recently considering mobility of users.

The mobile terminal includes an additional function for executing a game, and some other mobile terminals are implemented in a multimedia device. Furthermore, latest mobile terminals may receive broadcasting or multicasting signals so that users may watch videos or television programs.

In addition, the mobile terminal is provided with a short-range wireless communication means such as Bluetooth and provides a chatting service function which allows chatting with other terminals capable of performing short-range wireless communications while exchanging data or character messages with the terminals.

### SUMMARY OF THE INVENTION

Therefore, the present invention has been made in view of the above problems, and it is an object of the present invention to provide a within-a-radius chatting system and a service method thereof, which can perform chatting with users of mobile terminals positioned within a certain radius and meeting a user's search condition.

Another object of the present invention is to provide a within-a-radius chatting system and a service method thereof, which can register a user as a friend based on informal expression of good impression among users of mobile terminals positioned within a certain radius.

To accomplish the above objects, according to an embodiment of the present invention, there is provided a within-a-radius chatting system comprising: an application transmission unit for transmitting information on an application so that the application can be installed in a plurality of mobile terminals; a member join/authentication unit for joining a user of a first mobile terminal installed with the application as a member and authenticating membership of the user; a storage unit for storing membership information of the user joined as a member; a radius information receiving unit for receiving information on a chatting radius of the mobile terminal set by the user joined as a member; a position information receiving unit for receiving position information of the mobile terminal of the user joined as a member; a member search unit for determining whether or not a second mobile terminal of another member meeting a user's search condition is positioned within the chatting radius of the first mobile terminal based on the chatting radius information and the user's search condition manually set by the user of the first mobile terminal; and a chatting relay unit for controlling the application to enable chatting with a user of the second mobile terminal positioned within the chatting radius of the first mobile terminal and meeting the user's search condition.

If the user of the second mobile terminal goes out of the chatting radius while the user of the first mobile terminal performs chatting with the user of the second mobile terminal positioned within the chatting radius, the chatting relay unit confirms whether or not the user of the first mobile terminal and the user of the second mobile terminal have a relationship registered as friends. If the user of the first mobile terminal and the user of the second mobile terminal do not have a relationship registered as friends, the chatting relay unit may switch the second mobile terminal going out of the chatting radius to a state incapable of performing chatting with the first mobile terminal.

If the user of the second mobile terminal goes out of the chatting radius while the user of the first mobile terminal performs chatting with the user of the second mobile terminal positioned within the chatting radius, the chatting relay unit confirms whether or not the user of the first mobile terminal and the user of the second mobile terminal have a relationship registered as friends. If the user of the first mobile terminal and the user of the second mobile terminal have a relationship registered as friends, the chatting relay unit may maintain the second mobile terminal going out of the chatting radius and the first mobile terminal in a state capable of continuously performing chatting without interruption.

The chatting radius information received by the radius information receiving unit may be information that can be changed by the user of the first mobile terminal.

The within-a-radius chatting system may further comprise: a chatter registration unit for confirming whether or not the user of the first mobile terminal informally expresses a good impression toward the user of the second mobile terminal positioned within the chatting radius, confirming whether or not the user of the second mobile terminal informally expresses a good impression toward the user of the first mobile terminal, and registering the user of the first mobile terminal and the user of the second mobile terminal as friends if they informally express a good impression toward each other.

If it is confirmed that the user of the first mobile terminal informally expresses a good impression toward the user of the second mobile terminal positioned within the chatting radius, the chatter registration unit may confirm whether or not the first mobile terminal is positioned within the chatting radius set in the second mobile terminal.

If the first mobile terminal is positioned within the chatting radius set in second mobile terminal, the chatter registration unit may confirm whether or not the user of the second mobile terminal expresses a good impression toward the user of the first mobile terminal, and register the user of the first mobile terminal and the user of the second mobile terminal as friends if they informally express a good impression toward each other.

If the first mobile terminal is not positioned within the chatting radius set in the second mobile terminal, the chatter registration unit may convert the good impression expressed by an owner of the first mobile terminal into a request for making friends and transmit the request to the second mobile terminal as a message.

The member search unit may confirm whether or not the first mobile terminal is positioned within the chatting radius of the searched second mobile terminal.

The chatting relay unit may display whether or not the first mobile terminal is positioned within the chatting radius of the second mobile terminal on an interface handling screen of the first mobile terminal.

In addition, according to an embodiment of the present invention, there is provided a within-a-radius chatting service method for providing a chatting service in an environment of connecting a plurality of mobile terminals for providing the chatting service and a within-a-radius chatting system for relaying chatting to enable the chatting service among the mobile terminals, the method comprising the steps of: receiving and installing an application, by the plurality of mobile terminals; performing a process of joining users of the plurality of mobile terminals as a member and authenticating membership of the users; receiving chatting radiuses set by the users of the plurality of mobile terminals, by the within-a-radius chatting system; confirming whether or not second mobile terminals of other members meeting a user's search condition are positioned within a chatting radius of a first mobile terminal, if a user of the first mobile terminal among the plurality of mobile terminals executes the application and inputs the chatting radius and the user's search condition in the within-a-radius chatting system; and providing a chatting relay service between the user of the first mobile terminal and a user of the second mobile terminal positioned within the chatting radius of the first mobile terminal and meeting the user's search condition in the within-a-radius chatting system.

The within-a-radius chatting service method may further comprise the step of: confirming whether or not the first mobile terminal and the second mobile terminal have a relationship registered as friends, if the user of the second mobile terminal among the plurality of mobile terminals positioned within the chatting radius set by the user of the first mobile terminal goes out of the chatting radius of the first mobile terminal.

The within-a-radius chatting service method may further comprise the step of: maintaining the second mobile terminal going out of the chatting radius and the first mobile terminal in a state capable of continuously performing chatting without interruption, if the user of the first mobile terminal and the user of the second mobile terminal have a relationship registered as friends.

If the user of the first mobile terminal and the user of the second mobile terminal do not have a relationship registered as friends, the second mobile terminal going out of the chatting radius may be switched to a state incapable of performing chatting with the first mobile terminal.

The within-a-radius chatting service method may further comprise the step of: registering the user of the first mobile terminal and the user of the second mobile terminal positioned within the chatting radius of the first mobile terminal as friends if they informally express a good impression toward each other in the within-a-radius chatting system.

In the step of registering the user of the first mobile terminal and the user of the second mobile terminal positioned within the chatting radius of the first mobile terminal as friends if they informally express a good impression toward each other in the within-a-radius chatting system, if the user of the first mobile terminal informally expresses a good impression toward the user of the second mobile terminal and the user of the second mobile terminal informally expresses a good impression toward the user of the first mobile terminal, they may be registered as friends.

Informally expressing a good impression may be expressing a good impression without informing that the user of the first mobile terminal expresses a good impression toward the user of the second mobile terminal in the within-a-radius chatting system.

The within-a-radius chatting service method may further comprise the step of: confirming whether or not the first mobile terminal is positioned within the chatting radius of the second mobile terminal which is positioned within the chatting radius of the first mobile terminal, and displaying a result thereof on an interface handling screen of the first mobile terminal.

### BRIEF DESCRIPTION OF THE DRAWINGS

FIG. 1 is a block diagram showing the configuration of a mobile terminal used for operating a within-a-radius chatting system according to one aspect of the present invention.

FIG. 2 is a view illustrating a service setting method for data communication of a mobile terminal used for operating a within-a-radius chatting system according to one aspect of the present invention.

FIG. 3 is a block diagram showing the configuration of a within-a-radius chatting system according to an embodiment of the present invention.

FIG. 4 is a view briefly showing chatting radiuses of a plurality of mobile terminals.

FIGS. 5 to 7 are views showing interface screens displayed on a mobile terminal by executing an application.

FIG. 8 is a view showing detailed information display fields displayed when a detailed information display field of FIGS. 6 and 7 is clicked.

FIG. 9 is a flowchart illustrating the procedure of joining a member and setting a function of a within-a-radius chatting system according to an embodiment of the present invention.

FIG. 10 is a flowchart illustrating the control flow of a within-a-radius chatting system according to an embodiment of the present invention.

FIG. 11 is a flowchart illustrating the control flow of a within-a-radius chatting system according to an embodiment of the present invention.

FIG. 12 is a flowchart illustrating the control flow of a within-a-radius chatting system according to another embodiment of the present invention.

### DETAILED DESCRIPTION OF THE PREFERRED EMBODIMENT

The present invention will be hereafter described in detail with reference to the accompanying drawings.

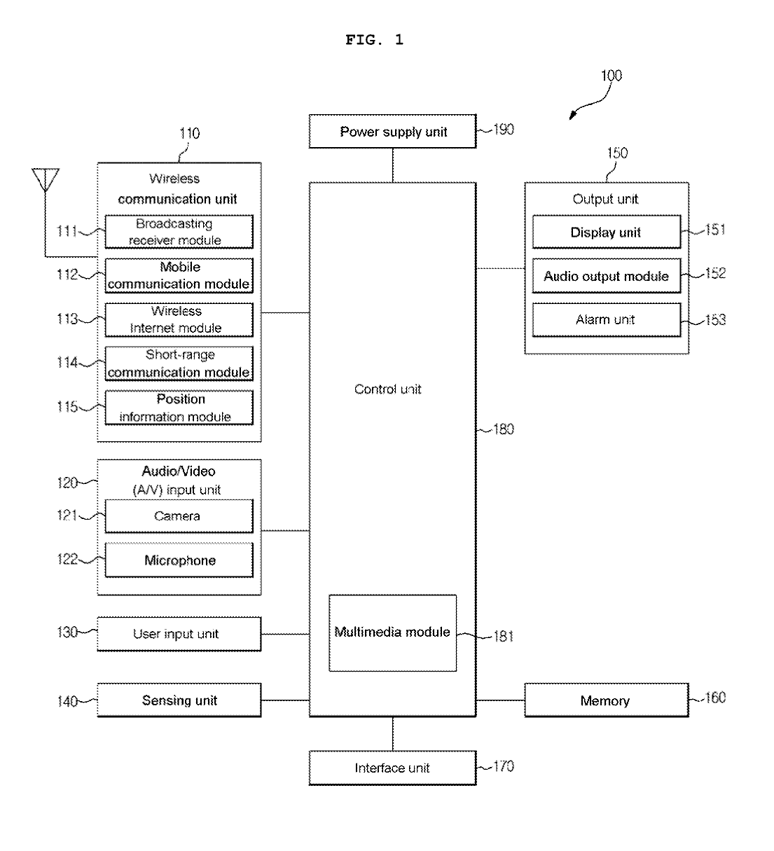

FIG. 1 is a block diagram showing the configuration of a mobile terminal used for operating a within-a-radius chatting system according to one aspect of the present invention.

The mobile terminal 100 can be implemented in a variety of forms. The mobile terminal may include a cellular phone, a smart phone, a notebook computer, a digital broadcasting terminal, a Personal Digital Assistant (PDA), a Portable Multimedia Player PMP), a navigator, and the like.

The mobile terminal 100 may include a wireless communication unit 110, an Audio/Video (A/V) input unit 120, a user input unit 130, a sensing unit 140, an output unit 150, a memory 160, an interface unit 170, a control unit 180, and a power supply unit 190. FIG. 1 shows a mobile terminal having a variety of constitutional components. However, all of the constitutional components shown in the figure are not a prerequisite constitutional component. The mobile terminal can be implemented using constitutional components more than or less than the constitutional components shown in the figure. Hereinafter, the constitutional components will be described in detail.

The wireless communication unit 110 may include one or more constitutional components allowing wireless communication between the mobile terminal 100 and a wireless communication system or between the mobile terminal 100 and a network in which the mobile terminal 100 is positioned. For example, the wireless communication unit 110 may include a broadcasting receiver module 111, a mobile communication module 112, a wireless Internet module 113, a short-range communication module 114, a position information module 115, and the like.

The broadcasting receiver module 111 receives broadcasting signals and/or broadcasting-related information from an external broadcasting management server through a broadcasting channel. The broadcasting channel may include a satellite channel and a terrestrial wave channel. The broadcasting management server described above may be a server which generates and transmits the broadcasting signals or the broadcasting-related information, or a server which receives and transmits previously generated broadcasting signals or broadcasting-related information to a terminal. The broadcasting-related information may be a broadcasting channel, a broadcasting program, or information related to a broadcasting service provider. The broadcasting signal may be a TV broadcasting signal, a radio broadcasting signal, or a data broadcasting signal.

The broadcasting signal or the broadcasting-related information received through the broadcasting receiver module 111 can be stored in the memory 160.

The mobile communication module 112 transmits and receives radio signals to and from at least one of a base station, an external terminal, and a server in a mobile communication network. Here, the radio signal may include various types of data according to transmission and reception of a voice call signal, a video communication call signal, or a character/multimedia message.

The wireless Internet module 113 is a module for wireless Internet connection. The wireless Internet module 113 can be an internal or external type.

The short-range communication module 114 is a module for short-range communication. A short-range communication technique may include Bluetooth communication, Radio Frequency Identification (RFID) communication, Infrared Data Association (IrDA) communication, Ultra Wideband (UWB) communication, and Zigbee communication.

The position information module 115 is a module for confirming or obtaining a position of the mobile terminal 100. A Global Position System (GPS) module is an example of the position information module 115. The GPS module receives position information from a plurality of satellites. The position information may include coordinate information expressed in latitude and longitude. For example, the GPS module measures accurate time and distance from three or more satellites and may accurately calculate current position from three different distances using trigonometry. A method of obtaining information on distance and time from the three satellites and correcting errors using one satellite can be used. Particularly, the GPS module may obtain even a correct time together with three-dimensional speed information, as well as latitude, longitude, and height.

The A/V input unit 120 is for inputting audio or video signals and may include a camera 121 and a microphone unit 122. The camera 121 may process video frames such as still images or video images obtained by an image sensor, in a video communication mode or a photographing mode. The processed video frames can be displayed on a display unit 151.

The video frames processed by the camera 121 can be stored in the memory 160 or transmitted outside through the wireless communication unit 110. Two or more cameras 121 can be provided.

The microphone unit 122 receives audio signals from outside through a microphone and processes the audio signals into electrical voice data in a communication mode, a recording mode, or a voice recognition mode. The processed voice data can be converted into a transmittable form and transmitted to a mobile communication base station through the mobile communication module 112 in the communication mode. A variety of noise canceling algorithms can be implemented in the microphone unit 122 in order to eliminate noises generated in the process of receiving the audio signals from outside.

The user input unit 130 generates input data for controlling operation of the mobile terminal by a user. The user input unit 130 may be configured with a keypad, a dome switch, a touchpad, a jog wheel, a jog switch, and the like. Particularly, if the touchpad constructs an inter-layer structure together with the display unit 151 described below, it can be referred to as a touch screen.

The sensing unit 140 senses current state of the mobile terminal 100, such as an open and close state of the mobile terminal 100, a position of the mobile terminal 100, whether or not a user contacts the mobile terminal 100, an azimuth of the mobile terminal 100, and speed-up/speed-down of the mobile terminal 100, and the like, and generates a generation signal (→ sensing signal) for controlling operation of the mobile terminal 100. For example, if the mobile terminal 100 is a type of a slide phone, opening or closing of the slide phone can be sensed. In addition, the sensing unit 140 takes charge of a sensing function related to whether or not the power supplying unit 190 supplies power, whether or not an external device of the interface unit 170 is defective, and the like.

The interface unit 170 functions as an interface to all external devices connected to the mobile terminal 100. For example, the interface unit 170 may include a wired/wireless headset port, an external recharger port, a wired/wireless data port, a memory card port, a port for connecting an apparatus provided with an identification module, an audio Input/Output (I/O) port, a video Input/Output (I/O) port, an earphone port, and the like.

Here, the identification module is a chip for storing various kinds of information for authenticating authority for using the mobile terminal 100, which may include a user identity module, a subscriber identity module, a general-purpose user identity module, and the like. An apparatus provided with the identification module can be manufactured in the form of a smart card.

The output unit 150 is for outputting an audio signal, a video signal, or an alarm signal, which may include the display unit 151, an audio output module 152, an alarm unit 153, and the like.

The display unit 151 displays the information processed by the mobile terminal 100. For example, the display unit 151 displays a User Interface (UI) or a Graphic User Interface (GUI) related to communication if the mobile terminal 100 is in the communication mode. In addition, the display unit 151 displays a photographed or received image, or a UI or GUI if the mobile terminal 100 is in the video communication mode or the photographing mode.

As described above, if the display unit 151 and the touchpad construct an inter-layer structure to be configured as a touch screen, the display unit 151 also can be used as an input apparatus, as well as an output apparatus. The display unit 151 may include at least one of a liquid crystal display, a thin film transistor liquid crystal display, an organic light emitting diode, a flexible display, and a three-dimensional display. In addition, two or more display units 151 may be provided depending on the implementation form of the mobile terminal 100.

The audio output module 152 outputs audio data received from the wireless communication unit 110 or stored in the memory 160 in a call signal receiving mode, a communication mode, a recording mode, a voice recognition mode, a broadcasting receive mode, or the like. In addition, the audio output module 152 outputs audio signals related to a function performed in the mobile terminal 100. The audio output module 152 may include a speaker, a buzzer, and the like.

The alarm unit 153 outputs a signal for informing an event generated by the mobile terminal 100. Examples of the event generated by the mobile terminal 100 include a signal reception, a message reception, a key signal input, and the like. The alarm unit 153 may output a signal for informing generation of an event in a form other than an audio signal or a video signal. For example, the alarm unit 153 may output a signal in the form of vibration.

The memory 160 may store a program for performing the process and control of the control unit 180 and perform a function of temporarily storing input and output data.

The control unit controls overall operation of the mobile terminal 100. For example, the control unit 180 performs controls and processes related to a voice communication, a data communication, or a video communication. The control unit 180 can be provided with a multimedia module 181 for playing back multimedia data. The multimedia module 181 can be implemented within the control unit 180 or can be implemented to be separate from the control unit 180.

The power supply unit 190 is supplied with external and internal power under the control of the control unit 180 and supplies power needed for operating each constitutional component.

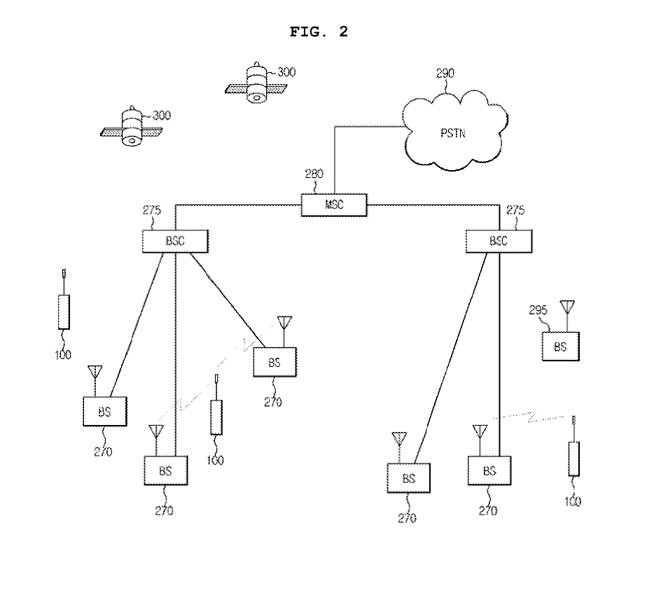

Hereinafter, a communication system in which a mobile terminal 100 related to the present invention may operate will be described with reference to FIG. 2.

A communication system according to one aspect of the present invention may use different wireless interfaces and/or physical layers. For example, a wireless interface that can be used by the communication system may include a frequency division multiple access, a time division multiple access, a code division multiple access, a universal mobile telecommunications system, and a global system for mobile communications. Hereinafter, a CDMA wireless communication system will be described as an example for the convenience of explanation. However, it is apparent that the present invention can be applied to all kinds of communication systems including the CDMA wireless communication system.

The CDMA wireless communication system may include a plurality of terminals 100, a plurality of base stations (BSs) 270, a plurality of base station controllers (BSCs) 275, and a mobile switching center (MSC) 280. The MSC 280 is configured to be connected to a Public Switched Telephone Network (PSTN) 290 and the BSCs 275. The BSCs 275 can be connected to the BSs 270 in pairs through a backhaul line. The backhaul line can be provided depending on at least one of E1/T1, ATM, IP, PPP, Frame Relay, HDSL, ADSL, and xDSL.

The BS 270 may include at least one sector, and each sector may include an omni-directional antenna or an antenna directing a specific radial direction from the BS 270. In addition, each sector may include two or more antennas of a variety of shapes. Each BS 270 may be configured to support allocation of a plurality of frequencies, and each of the plurality of allocated frequencies has a specific spectrum (e.g., 1.25 MHz, 5 MHz, or the like).

An intersection between the sector and the frequency allocation can be referred to as a CDMA channel. The BS 270 can be referred to as a Base Station Transceiver Subsystem (BTS). In this case, a combination of one BSC 275 and at least one BS 270 can be referred to as a term ‘base station’. The base station may represent a “cell site”. A plurality of sectors for a specific BS may be referred to as a plurality of cell sites, respectively.

A broadcasting transmitter (BT) transmits broadcasting signals to the terminals 100 operating within the system. The broadcasting receiver module 111 of FIG. 1 is provided in the terminal 100 in order to receive the broadcasting signals transmitted by the BT 295.

The satellite 300 assists to detect a position of at least one terminal among the plurality of terminals 100. The satellite is provided with a GPS. Although two satellites are shown in FIG. 2, useful position information can be acquired through less than or more than two satellites. The GPS module 115 shown in FIG. 1 cooperates with the satellites 300 in order to acquire desired position information. Here, the position can be traced using all techniques that can trace the position, as well as GPS trace techniques.

The BS 270 receives reverse link signals from a variety of terminals 100. The terminals 100 may be in a state of connecting a call, transmitting and receiving a message, or performing other communication operations. The reverse link signals received by a specific base station 270 are respectively processed within the specific base station 270. Data generated by the process described above is transmitted to a connected BSC 275. The BSC 275 provides a call resource allocation function and a mobility management function, including systemization of soft hand-offs among the base stations 270. In addition, the BSC 275 transmits the received data to the MSC 280 and provides an additional transmission service to connect to a PSTN 290. Similarly, the PSTN 290 is connected to the MSC 280, and the MSC 280 is connected to the BSCs 275. The BSC 275 controls the BSs 270 to transmit forward link signals to the terminals 100.

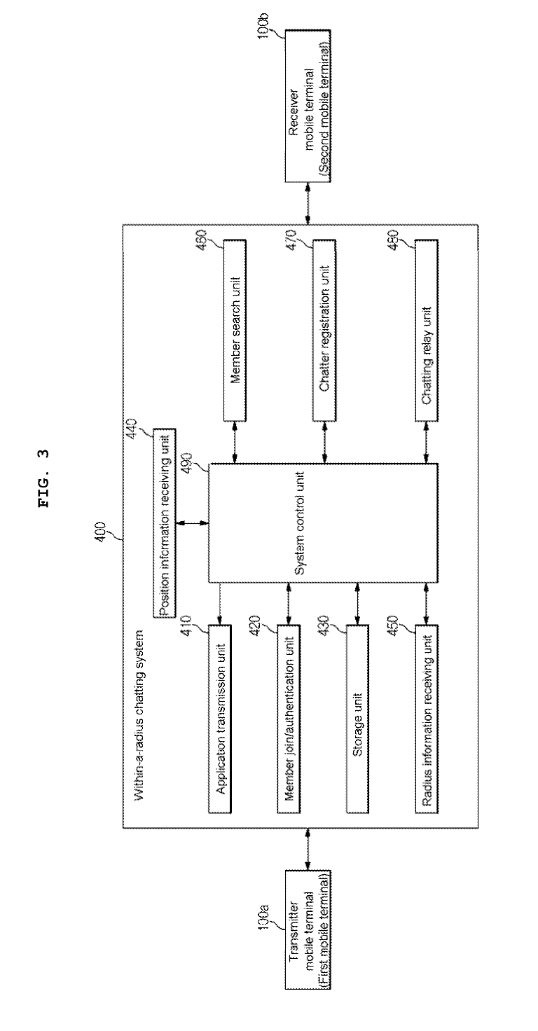

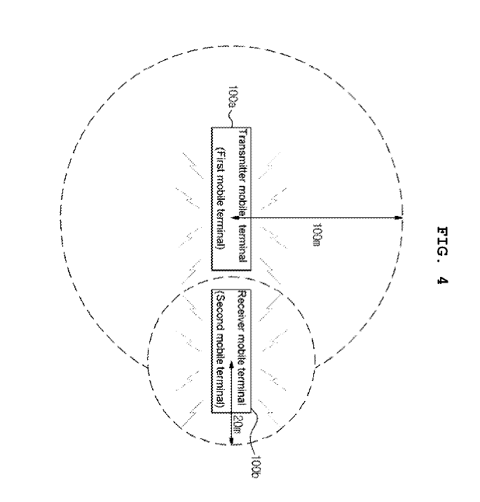

FIG. 3 is a block diagram showing the configuration of a within-a-radius calling system according to an embodiment of the present invention, and FIG. 4 is a view briefly showing chatting radiuses of a plurality of mobile terminals.

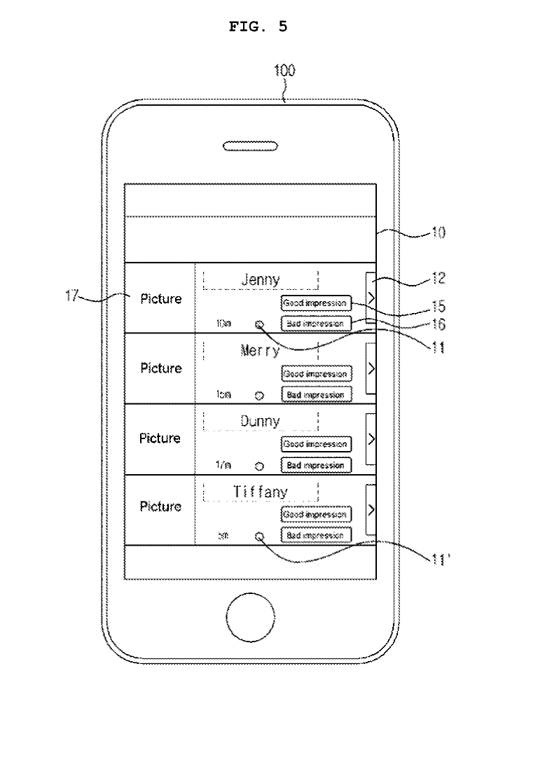

FIGS. 5 to 7 are views showing interface screens displayed on a mobile terminal by executing an application.

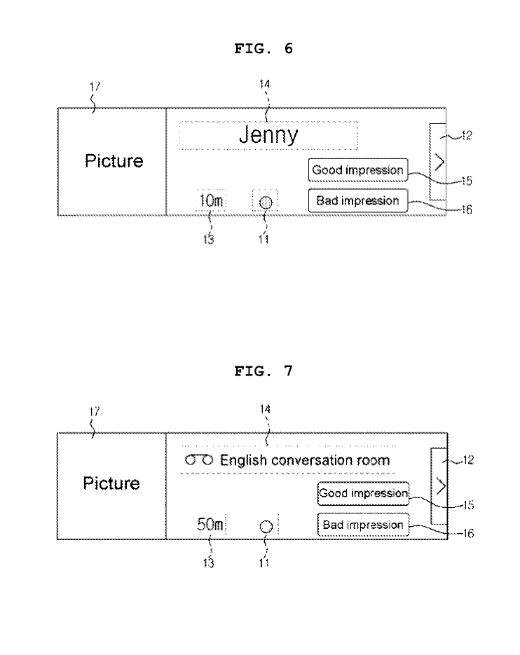

FIG. 8 is a view showing detailed information display fields displayed when a detailed information display field of FIGS. 6 and 7 is clicked.

The within-a-radius calling system 400 may include an application transmission unit 410, a member join/authentication unit 420, a storage unit 430, a position information receiving unit 440, a radius information receiving unit 450, a member search unit 460, a chatter registration unit 470, a within-a-radius calling unit 480, and a system control unit 490.

The application transmission unit 410 transmits information on an application to the mobile terminal 100. The application information may be an application installation program. The application information may be a Java application. However, the application information is not limited to the Java application, and a variety of program systems can be used. The mobile terminal 100 may install a corresponding application if the application information is received.

The member join/authentication unit 420 performs joining a user using the mobile terminal 100 as a member and authenticating membership of the user. Joining a member is collecting information on the user and joining the user as a member so that the user may use the application. The membership authentication is receiving authentication information transmitted from the user joined as a member and authenticating membership of the user based on the received authentication information so that the user may execute the application.

The storage unit 430 stores membership information of the user joined as a member. The membership information is information including a personal profile such as a name, an address, a picture, height, weight, characters, and the like.

The position information receiving unit 440 receives position information of the mobile terminal 100. The position information module 115 provided in the mobile terminal 100 measures the position information of the mobile terminal 100. The position information module 115 is a module for confirming or obtaining a position of the mobile terminal 100. The position information module 115 may include a GPS module. The GPS module receives position information from three or more satellites. The GPS module may accurately calculate current position from three pieces of position information using trigonometry. Here, the position information may include latitude, longitude, height and three-dimensional speed information.

The radius information receiving unit 450 receives radius setting information of the mobile terminal 100. The radius setting information is radius information manually set by a user. The radius information is information on a radius which is set based on the position of the mobile terminal 100.

The member search unit 460 may search for members based on position information of a transmitter mobile terminal 100a and a receiver mobile terminal 100b and radius information set by the transmitter mobile terminal 100a. The member search unit 460 searches for users, i.e., members, of the receiver mobile terminals 100b positioned within a previously set radius from the position of the transmitter mobile terminal 100a. For example, if the radius setting information of the transmitter mobile terminal 100a is 50 m, the member search unit 460 searches for other members positioned within the radius of 50 m from the transmitter mobile terminal 100a.

The member search unit 460 may search for members based on position information of a transmitter mobile terminal 100a and a receiver mobile terminal 100b and radius information set by the transmitter mobile terminal 100a.

As described above, the member search unit 460 may search for members positioned within a radius of each other based on radius information set for the transmitter mobile terminal 100a and radius information set for the receiver mobile terminal 100b.

In addition, the member search unit 460 may search for members based on a user's search condition and a chatting radius set by the user of the transmitter mobile terminal 100a. Here, the user's search condition may be a condition for the information desired to be searched by the user, other than the chatting radius. For example, if the user of the transmitter mobile terminal 100a sets the chatting radius as 100 m and the user's search condition as “TOEIC”, the member search unit 460 may search for receiver mobile terminals 100b positioned within the chatting radius of 100 m and having a word “TOEIC” in their profile information.

Meanwhile, information on the user of the receiver mobile terminal 100b positioned within the set radius is displayed on the transmitter mobile terminal 100a, and if the transmitter mobile terminal 100a is positioned within the radius of the receiver mobile terminal 100b, information on the user of the receiver mobile terminal 100b can be displayed. Referring to FIG. 5, a mutual recognition indicator 11 turned on in an on/off fashion is provided on the screen of the mobile terminal 100. Assuming that a mobile terminal 100 having an interface handling screen 10 shown in FIG. 5 is the transmitter mobile terminal 100a, if the receiver mobile terminal 100b is positioned within the range of the radius of the transmitter mobile terminal 100a and the transmitter mobile terminal 100a is also positioned within the range of the radius of the receiver mobile terminal 100b, the mutual recognition indicator 11 on the interface handling screen of the transmitter mobile terminal 100a is turned on. That is, if the mobile terminal 100 of a user is positioned within the range of the radius of the mobile terminal 100 of a counterpart, the mutual recognition indicator 11 is turned on. The user of the transmitter mobile terminal 100a may come to know whether or not the user of the receiver mobile terminal 100b recognizes the user of the transmitter mobile terminal 100a based on on/off of the mutual recognition indicator 11. Meanwhile, the mutual recognition indicator 11 may be expressed in a character or a picture, not in the form of a variation based on on/off, and a variety of methods other than the mutual recognition indicator 11 can be used. Reference number 11 of FIG. 5 indicates a turned on state of the mutual recognition indicator 11, and reference number 11′ indicates a turned off state of the mutual recognition indicator 11′.

Meanwhile, the fields displayed on the interface handling screen 10 can be controlled by the system control unit 490 of the within-a-radius chatting system 400. The system control unit 490 controls the chatting relay unit 480 to control on and off of the display fields of the interface handling screen 10 related to relay of chatting.

The user of the transmitter mobile terminal 100a may perform chatting or transmission and reception of a message with the members searched within the radius.

The chatter registration unit 470 may automatically or manually set a member using the transmitter mobile terminal 100 and a member positioned within the previously set radius of the transmitter mobile terminal 100a as friends.

If the user of the transmitter mobile terminal 100a and the user of the receiver mobile terminal 100b positioned within the previously set radius have contact information (a phone number, a mail, or the like) of each other, the chatter registration unit 470 may automatically set the two users as friends.

If only the user of the transmitter mobile terminal 100a among the user of the transmitter mobile terminal 100a and the user of the receiver mobile terminal 100b positioned within the previously set radius has contact information of the counterpart, the chatter registration unit 470 may set the two users as friends only when the user of the transmitter mobile terminal 100a requests to make friends and the counterpart accepts the request.

In addition, the chatter registration unit 470 can be designed such that if only either of the user of the transmitter mobile terminal 100a or the user of the receiver terminal 100b positioned within the previously set radius has contact information of the counterpart, the user having the contact information automatically requests the counterpart to make friends.

In the case where the user of the transmitter mobile terminal 100a and the user of the receiver mobile terminal 100b positioned within a previously set radius do not know contact information of each other, the chatter registration unit 470 may set the two users as friends if the user of the transmitter mobile terminal 100a expresses a good impression and the user of the receiver mobile terminal 100b also expresses a good impression.

Meanwhile, if the receiver mobile terminal 100b is positioned within the chatting radius of the transmitter mobile terminal 100a and the transmitter mobile terminal 100a is not positioned within the chatting radius of the receiver mobile terminal 100b as shown in FIG. 4, information on the member using the receiver mobile terminal 100b is searched at the transmitter mobile terminal 100a, but information on the member using the transmitter mobile terminal 100a is not searched at the receiver mobile terminal 100b. In this case, the user of the transmitter mobile terminal 100a may transmit a request for chatting and a message to the user of the receiver mobile terminal 100b, and if the request for chatting is accepted, the user of the receiver mobile terminal 100b may chat with the user of the transmitter mobile terminal 100a and answer the message transmitted from the user of the transmitter mobile terminal 100a. However, information on the user of the transmitter mobile terminal 100a is not searched at the receiver mobile terminal 100b until the chatting radius is re-set.

Meanwhile, the chatter registration unit 470 may be provided with a function of setting a friend based on the expression of good impression. The function of setting a friend based on a good impression is different from a function of setting a friend according to a request for making friends. The function of setting a friend according to a request for making friends sets users as friends when a user formally requests a counterpart to accept a request for making friends and the counterpart accept the request, whereas in the function of setting a friend based on a good impression, if a user informally expresses a good impression toward the counterpart (the counterpart does not know that the user expresses a good expression toward the counterpart), and the counterpart expresses a good impression toward the user who expresses a good expression toward the counterpart, unknowing that the counterpart itself is a target of the expression of good impression, the users can be friends since both of the users express a good impression toward each other.

Meanwhile, if the profile of a user positioned within a previously set radius is displayed on the mobile terminal 100, the user of the transmitter mobile terminal 100a may express a good impression toward a favorable counterpart with reference to the profile. In this case, if the receiver mobile terminal 100b is positioned within the radius set by the transmitter mobile terminal 100a and the transmitter mobile terminal 100a is not positioned with the radius set by the receiver mobile terminal 100b, the expression of good impression is converted into a request for making friends and transmitted to the counterpart. This is a function created considering that the receiver mobile terminal 100b cannot express a good impression since the user of the transmitter mobile terminal 100a is not searched.

Meanwhile, the user of the transmitter mobile terminal 100a may use expression of bad impression, in addition to the expression of good impression described above. If the user of the transmitter mobile terminal 100a marks a bad impression (by checking reference number 16) for a user of any one mobile terminal among receiver mobile terminals 100b positioned within a chatting radius, the user of the transmitter mobile terminal 100a may avoid showing his or her profile to the user of the receiver mobile terminal 100b.

Meanwhile, marking a good impression is checking the good impression button 15 placed on the interface handling screen 10, and marking a bad impression is checking the bad impression button 16 placed on the interface handling screen 10.

Meanwhile, the concept of the transmitter mobile terminal 100a and the receiver mobile terminal 100b is introduced to classify mobile terminals from the viewpoint of a user, and there is no difference between the terms of a transmitter and a receiver among the mobile terminals 100a and 100b. That is, a user currently searching for information on other members by executing an application using the mobile terminal 100 can be regarded as a transmitter, and a searched member is regarded as a receiver. In addition, the transmitter mobile terminal 100 can be expressed as a first mobile terminal, and the receiver mobile terminal 100b can be expressed as a second mobile terminal. In addition, although only one receiver mobile terminal 100b is shown in the drawing for the convenience of explanation, at least one or more receiver mobile terminals 100b exist.

In addition, making friends between users of mobile terminals 100 is switching to a state capable of communicating with each other using a function of chatting or transmitting a message that can be used in a chatting application. In the within-a-radius chatting system according to one aspect of the present invention, members may freely chat or transmit and receive messages within a radius. However, if a user goes out of the radius, the function of chatting or transmitting and receiving a message can be performed only among the users registered as friends.

The chatting relay unit 480 may create a program environment so that chatting is allowed if other members are positioned within a chatting radius of a specific mobile terminal 100 (switch to a state capable of chatting among members by controlling the application). If the chatting relay unit 490 creates the chatting environment, the specific mobile terminal 100 and the other mobile terminals 100 positioned within the radius may perform chatting.

The chatting relay unit 480 may relay chatting by applying both a condition and a chatting radius set by the user of the transmitter mobile terminal 100a. For example, if the user of the transmitter mobile terminal 100a sets a condition for a counterpart, such as height, age, gender and the like, and a chatting radius, the chatting relay unit 480 may relay chatting so that only the users positioned within the chatting radius and having a profile meeting the condition set by the user may take part in the chatting. In addition, the condition set by the user may include a knowledge condition. The knowledge condition is information on the knowledge of foreign languages, science, and the like. A user of a mobile terminal 100 may store information on the knowledge that the user has, in addition to the profile. For example, if the user of the transmitted mobile terminal 100a searches for members having a knowledge on TOEIC within a chatting radius, the chatting relay unit 480 may relay the chatting so that the user may chat with a user positioned within the chatting radius, who has stored information including a word TOEIC as information on his or her knowledge. Here, the relay may be displaying users having knowledge information on the interface handling screen 10 so that only the users of mobile terminals 100 may chat with one another.

The chatting relay unit 480 may create an environment in which group chatting is allowed among the users of mobile terminals 100 positioned within a chatting radius to be overlapped with one another (when an intersection is formed between the chatting radius of the transmitter mobile terminal and the chatting radius of the receiver mobile terminal). Referring to FIG. 7, if a field indicating an English conversation room is displayed in the title display field 14 of the transmitter mobile terminal 100a and a user of another mobile terminal 100 positioned within the chatting radius clicks the title display field 14, both of the mobile terminals 100 are switched to a chatting state. At this point, a chatting room is created if one of the users clicks the title display field 14, and a user of another mobile terminal may enter the created chatting room by subsequently clicking the title display field 14. That is, users of the other mobile terminals 100 may subsequently enter the created chatting room.

On the other hand, a mutual recognition indicator 11, a detailed information button 12, a distance information field 13, a title display field 14, a good impression button 15, a bad impression button 16, and a picture field 17 may be displayed on the interface handling screen 10 of FIGS. 5 to 7.

Meanwhile, a phrase for advertising a store or a shop can be inputted in the title display field 14 of FIGS. 5 to 7, and it can be handled to display detailed advertisement of the store or detailed descriptions of a product if the detailed information button 12 is clicked.

Meanwhile, referring to FIG. 8, if the detailed information button 12 of FIGS. 6 and 7 is clicked, the detailed information display field shown in FIG. 8 is displayed. The detailed information display field may include a picture field, a title field, a name field, an age field, and a knowledge field. Meanwhile, although it is not shown in the figure, the detailed information display field may include a disclosure of minimum information setting field and a closed information setting field.

If a member stayed within a radius of a specific mobile terminal 100 goes out of the corresponding radius, the chatting relay unit 480 confirms whether or not the member going out of the radius has a relationship registered as a friend of the member possessing the specific mobile terminal 100.

If the member going out of the radius of the specific mobile terminal 100 has a relationship registered as a friend of the member possessing the specific mobile terminal 100 in the application, the chatting relay unit 480 allows the chatting to be continued without interruption.

If the member going out of the radius of the specific mobile terminal 100 does not have a relationship registered as a friend of the member of the specific mobile terminal 100, the chatting relay unit 480 may switch the member going out of the radius to a state incapable of performing chatting.

Meanwhile, the chatting relay unit 480 may control the chatting system so as not to display information on a member who requests blocking of information disclosure among the members searched by the member search unit 460 on the other mobile terminals 100. The user of the mobile terminal 100 may handle the interface of the application in order to set disclosure and closure of minimum information at user's own will.

The system control unit 490 manages overall control of the within-a-radius chatting system 400. The system control unit 490 controls the application transmission unit 410 to transmit information on the application if the mobile terminal 100 requests information on the application, controls the member join/authentication unit 420 to proceed its procedure if joining or authentication of a member is requested, controls the member search unit 460 to search for other members positioned within a corresponding radius based on radius setting information if the radius setting information is received from the mobile terminal 100, and controls the chatter registration unit 470 to set the members as friends according to a request for making friends or expression of good impression so that the functions of the application can be used among the members.

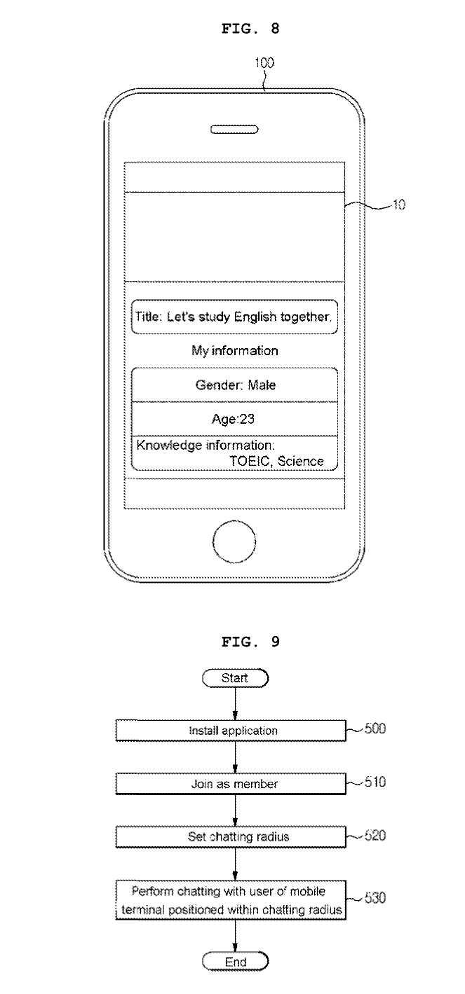

FIG. 9 is a flowchart illustrating the procedure of joining a member and setting a function of a within-a-radius chatting system according to an embodiment of the present invention.

The user of the mobile terminal 100 may download an application from the within-a-radius chatting system 400 and install the application. (step 500) The application may display members positioned within a certain radius from the position of the mobile terminal 100 and allow chatting or transmitting and receiving messages among the members positioned within the radius. The application is a computer program capable of performing a function of setting a friend based on a formal request for making friends or informal expression of good impression.

After executing the application, the user of the mobile terminal 100 joins as a member of the within-a-radius chatting system 400 according to a procedure of joining a member. The user of the mobile terminal 100 may select disclosed or closed information from the profile recorded when the user joins as a member. The profile set as disclosed information by the user of the mobile terminal 100 is information disclosed to other members when the mobile terminal 100 of the user is positioned within a chatting radius previously set by other members. The disclosed information may include information on a picture, height, appearance, and the like. (step 510)

The user of the mobile terminal 100 may set a chatting radius by executing the application after joining as a member. If the chatting radius is set, all members positioned within the radius which is set when the application is executed are displayed. The user of the transmitter mobile terminal 100a may chat with the displayed members positioned within the radius. If a member who has not been set as a friend among the members positioned within the range of the radius of the transmitter mobile terminal 100a goes out of the range of the radius, the chatting is terminated. On the other hand, if a member set as a friend among the members positioned within the range of the radius of the transmitter mobile terminal 100a goes out of the range of the radius, the chatting is not terminated. (steps 520 and 530)

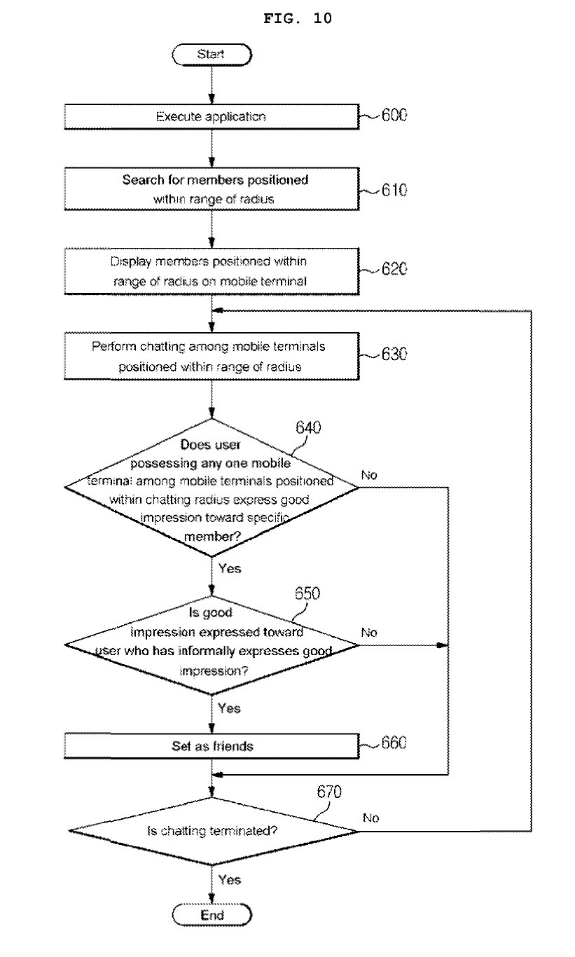

FIG. 10 is a flowchart illustrating the control flow of a within-a-radius chatting system according to an embodiment of the present invention.

If the owner of the mobile terminal 100 executes the application, the member search unit 460 of the within-a-radius chatting system 400 searches for members positioned within a radius. The radius is individually determined by the user. For example, the radius may be 50 m, 100 m, 200 m, 1,000 m, or the like. (steps 600 and 610)

Next, the mobile terminal 100 displays information on the members positioned within the radius and searched by the member search unit 460 on the application screen window. The member information may be a profile of a member including height, weight, and the like. The user of the mobile terminal 100 may chat with the displayed members positioned within the radius. The chatting may be performed in a group after creating a chatting room or performed in the form of exchanging messages one-to-one. (steps 620 and 630)

Next, it is confirmed whether or not a member possessing a specific mobile terminal 100 expresses a good impression toward a member possessing another mobile terminal 100 positioned within the radius. The good impression is expressed informally. Informally expressing a good impression is transmitting information on expression of good impression to the chatter registration unit 470 of the within-a-radius chatting system 400 to be unnoticed by the member who receives the expression of good impression. (step 640)

Next, it is confirmed whether or not the member informally receiving the expression of good impression from the member possessing the specific mobile terminal 100 in step 640 expresses a good impression toward the member who expresses the good impression. (step 650)

Next, if it is confirmed that the member possessing the specific mobile terminal 100 and the member possessing another mobile terminal 100 express a good impression toward each other, the chatter registration unit 470 registers the members as friends. (step 660)

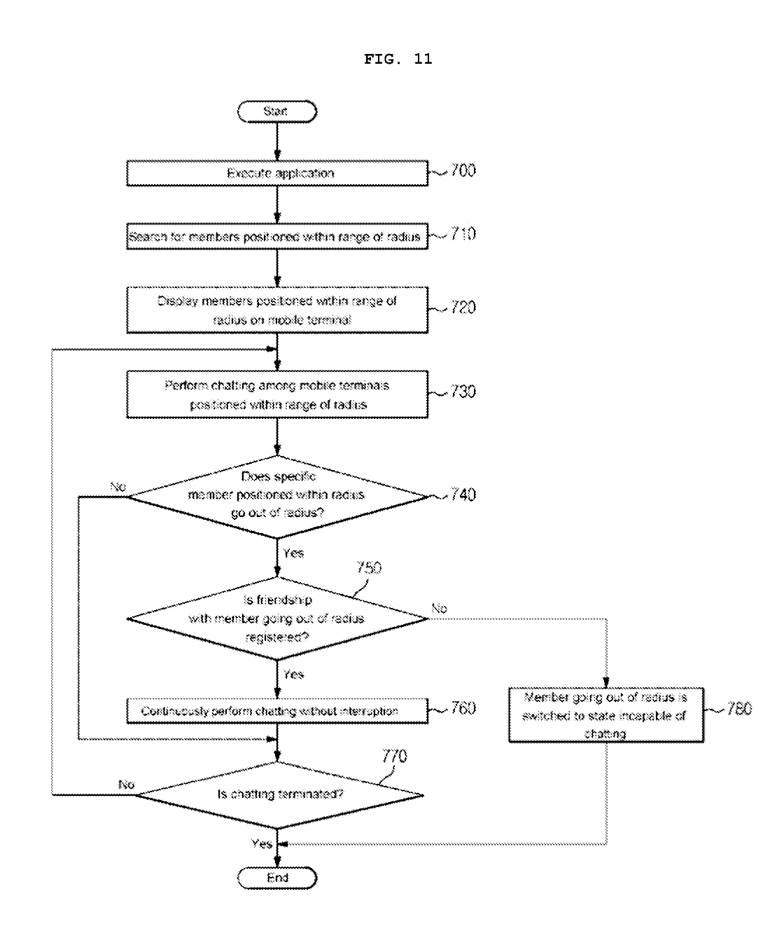

FIG. 11 is a flowchart illustrating the control flow of a within-a-radius chatting system according to an embodiment of the present invention.

If the owner of the mobile terminal 100 executes the application, the member search unit 460 of the within-a-radius chatting system 400 searches for members positioned within a radius. (steps 700 and 710)

Next, the mobile terminal 100 displays information on the members positioned within the radius and searched by the member search unit 460 on the application screen window. The user of the mobile terminal 100 may chat with the displayed members positioned within the radius. The chatting may be performed in a group after creating a chatting room or performed in the form of exchanging messages one-to-one. (steps 720 and 730)

Next, the chatting relay unit 480 confirms whether or not a member positioned within the radius goes out of the corresponding radius. The chatting relay unit 480 may confirm whether or not the mobile terminal 100 of the member stayed within the radius of a specific mobile terminal 100 goes out of the corresponding radius based on position information of the mobile terminal 100 transmitted from the position information receiving unit 440. (step 740)

Next, if the mobile terminal 100 of the member stayed within the radius of the specific mobile terminal 100 goes out of the corresponding radius, the chatting relay unit 480 confirms whether or not the member going out of the radius of the specific mobile terminal 100 has a relationship registered as a friend of the member of the specific mobile terminal 100. (steps 740 and 750)

Next, if the member going out of the radius of the specific mobile terminal 100 has a relationship registered as a friend of the member of the specific mobile terminal 100, the chatting relay unit 480 allows the chatting to be continued without interruption. (step 760)

On the other hand, if the member going out of the radius of the specific mobile terminal 100 does not have a relationship registered as a friend of the member of the specific mobile terminal 100, the chatting relay unit 480 switches the member going out of the radius to a state incapable of performing chatting. (step 780)

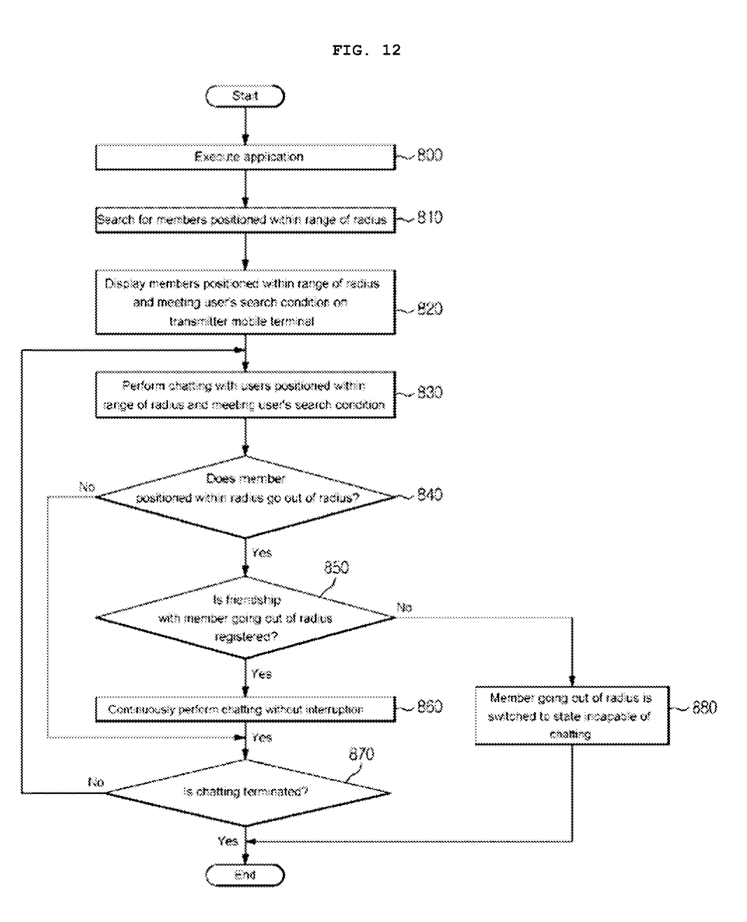

FIG. 12 is a flowchart illustrating the control flow of a within-a-radius chatting system according to another embodiment of the present invention.

Since the steps of FIG. 12 are the same as those of FIG. 7, other than that steps 720 and 730 are changed, descriptions of FIG. 12 will be replaced with those of FIG. 11.

Steps 820 and 830 of FIG. 12, which are the differences from FIG. 11, will be described below.

The user of the transmitter mobile terminal 100a may input a user's search condition in addition to the chatting radius and search for receiver mobile terminals 100b. The user's search condition may be a condition for the profile and knowledge information. The chatting relay unit 480 may display a profile of a user of the receiver mobile terminal 100b on the interface handling screen 10 considering information on the user's search condition and the chatting radius set by the user of the transmitter mobile terminal 100a. For example, the user of the transmitter mobile terminal 100a may set the chatting radius as 500 m and input “TOEIC” as a condition for the knowledge information. The member search unit 460 may search for receiver mobile terminals 100b positioned within the chatting radius of 500 m, which have inputted “TOEIC” in their own profile as a condition for the knowledge information, and the chatting relay unit 480 may relay chatting based on the information on the user's search condition and the chatting radius.

As described above in detail, according to one aspect of the present invention, it is effective in that it is possible to have a chat with users meeting a user's search condition within a certain radius among the members joined the within-a-radius chatting system.

According to another aspect of the present invention, it is effective in that members performing chatting within a certain radius can be registered as friends by expressing a good impression toward one another.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1-18. (canceled)

19. A within-a-radius chatting system comprising:
an application transmission unit for transmitting information on an application so that the application can be installed in a plurality of mobile terminals;
a member join/authentication unit for joining a user of the mobile terminal installed with the application as a member and authenticating membership of the user;
a storage unit for storing membership information of the user joined as a member;
a radius information receiving unit for receiving information on a chatting radius of the mobile terminal;
a position information receiving unit for receiving position information of the mobile terminal of the user joined as a member;
a member search unit for determining whether or not a second mobile terminal of another member is positioned within the chatting radius of a first mobile terminal among the plurality of mobile terminals; and
a chatting relay unit for relaying chatting performed with a user of the second mobile terminal positioned within the chatting radius of the first mobile terminal, wherein
the chatting relay unit confirms whether or not a user of the first mobile terminal and the user of the second mobile terminal have a relationship registered as friends if the user of the second mobile terminal goes out of the chatting radius.

20. The system according to claim 19, wherein if the user of the first mobile terminal and the user of the second mobile terminal do not have a relationship registered as friends, the chatting relay unit switches the second mobile terminal going out of the chatting radius to a state incapable of performing chatting with the first mobile terminal.

21. The system according to claim 19, wherein if the user of the first mobile terminal and the user of the second mobile terminal have a relationship registered as friends, the chatting relay unit maintains the second mobile terminal going out of the chatting radius and the first mobile terminal in a state capable of continuously performing chatting without interruption.

22. The system according to claim 19, wherein the chatting radius information received by the radius information receiving unit is information that can be changed by the user of the first mobile terminal.

23. The system according to claim 19, further comprising:
a chatter registration unit for confirming whether or not the user of the first mobile terminal informally expresses a good impression toward the user of the second mobile terminal positioned within the chatting radius, confirming whether or not the user of the second mobile terminal informally expresses a good impression toward the user of the first mobile terminal, and registering the user of the first mobile terminal and the user of the second mobile terminal as friends if they informally express a good impression toward each other.

24. The system according to claim 23, wherein if it is confirmed that the user of the first mobile terminal informally expresses a good impression toward the user of the second mobile terminal positioned within the chatting radius, the chatter registration unit confirms whether or not the first mobile terminal is positioned within the chatting radius set in the second mobile terminal.

25. The system according to claim 24, wherein if the first mobile terminal is positioned within the chatting radius set in second mobile terminal, the chatter registration unit confirms whether or not the user of the second mobile terminal expresses a good impression toward the user of the first mobile terminal, and registers the user of the first mobile terminal and the user of the second mobile terminal as friends if they informally express a good impression toward each other.

26. The system according to claim 24, wherein if the first mobile terminal is not positioned within the chatting radius set in the second mobile terminal, the chatter registration unit converts the good impression expressed by an owner of the first mobile terminal into a request for making friends and transmits the request to the second mobile terminal as a message.

27. The system according to claim 19, wherein the member search unit confirms whether or not the first mobile terminal is positioned within the chatting radius of the searched second mobile terminal.

28. The system according to claim 27, wherein the chatting relay unit displays whether or not the first mobile terminal is positioned within the chatting radius of the second mobile terminal on an interface handling screen of the first mobile terminal.

29. A within-a-radius chatting service method for providing a chatting service in an environment of connecting a plurality of mobile terminals for providing the chatting service and a within-a-radius chatting system for relaying chatting to enable the chatting service among the mobile terminals, the method comprising the steps of:
receiving and installing an application, by the plurality of mobile terminals;
performing a process of joining users of the plurality of mobile terminals as a member and authenticating membership of the users;
receiving chatting radiuses set by the users of the plurality of mobile terminals, by the within-a-radius chatting system;
confirming whether or not second mobile terminals of other members meeting a user's search condition are positioned within a chatting radius of a first mobile terminal, if a user of the first mobile terminal among the plurality of mobile terminals executes the application and inputs the chatting radius and the user's search condition in the within-a-radius chatting system; and
providing a chatting relay service between the user of the first mobile terminal and a user of the second mobile terminal positioned within the chatting radius of the first mobile terminal and meeting the user's search condition in the within-a-radius chatting system, wherein
the within-a-radius chatting service method further comprises the step of confirming whether or not the first mobile terminal and the second mobile terminal have a relationship registered as friends, if the user of the second mobile terminal among the plurality of mobile terminals positioned within the chatting radius set by the user of the first mobile terminal goes out of the chatting radius of the first mobile terminal.

30. The method according to claim 29, further comprising the step of: maintaining the second mobile terminal going out of the chatting radius and the first mobile terminal in a state capable of continuously performing chatting without interruption, if the user of the first mobile terminal and the user of the second mobile terminal have a relationship registered as friends.

31. The method according to claim 29, wherein if the user of the first mobile terminal and the user of the second mobile terminal do not have a relationship registered as friends, the second mobile terminal going out of the chatting radius is switched to a state incapable of performing chatting with the first mobile terminal.

32. The method according to claim 29, further comprising the step of: registering the user of the first mobile terminal and the user of the second mobile terminal positioned within the chatting radius of the first mobile terminal as friends if they informally express a good impression toward each other in the within-a-radius chatting system.

33. The method according to claim 32, wherein in the step of registering the user of the first mobile terminal and the user of the second mobile terminal positioned within the chatting radius of the first mobile terminal as friends if they informally express a good impression toward each other in the within-a-radius chatting system, if the user of the first mobile terminal informally expresses a good impression toward the user of the second mobile terminal and the user of the second mobile terminal informally expresses a good impression toward the user of the first mobile terminal, they are registered as friends.

34. The method according to claim 32, wherein informally expressing a good impression is expressing a good impression without informing that the user of the first mobile terminal expresses a good impression toward the user of the second mobile terminal in the within-a-radius chatting system.

35. The method according to claim 29, further comprising the step of: confirming whether or not the first mobile terminal is positioned within the chatting radius of the second mobile terminal which is positioned within the chatting radius of the first mobile terminal, and displaying a result thereof on an interface handling screen of the first mobile terminal.

36. A within-a-radius chatting service method for providing a chatting service in an environment of connecting a plurality of mobile terminals for providing the chatting service and a within-a-radius chatting system for relaying chatting to enable the chatting service among the mobile terminals, the method comprising the steps of:
receiving and installing an application, by the plurality of mobile terminals;
performing a process of joining users of the plurality of mobile terminals as a member and authenticating membership of the users;
receiving chatting radiuses set by the users of the plurality of mobile terminals, by the within-a-radius chatting system;
confirming whether or not second mobile terminals of other members meeting a user's search condition are positioned within a chatting radius of a first mobile terminal, if a user of the first mobile terminal among the plurality of mobile terminals executes the application and inputs the chatting radius and the user's search condition in the within-a-radius chatting system;
providing a chatting relay service between the user of the first mobile terminal and a user of the second mobile terminal positioned within the chatting radius of the first mobile terminal and meeting the user's search condition in the within-a-radius chatting system; and
maintaining the second mobile terminal in a state capable of continuously performing chatting with the first mobile terminal without interruption even when the second mobile terminal goes out of the chatting radius of the of first mobile terminal, if the user of the first mobile terminal and the user of the second mobile terminal have a relationship registered as friends.
